(19) United States
(12) Patent Application Publication
(10) Pub. No.: US 2026/0230747 A1
(43) Pub. Date: Aug. 6, 2026

(54) PHASE PLUG FOR COMPRESSION DRIVERS

(71) Applicant: B&C SPEAKERS S.p.A., Firenze (IT)

(72) Inventors: Valentina Cardinali, Firenze (IT); Andrea Casadei, Firenze (IT); Phillip Graham, Tucker, GA (US)

(21) Appl. No.: 19/465,621

(22) Filed: Jan. 30, 2026

Related U.S. Application Data
(60) Provisional application No. 63/753,191, filed on Feb. 3, 2025.

(51) Int. Cl. H04R 1/34

(52) U.S. Cl. CPC H04R 1/345; H04R 2201/34; H04R 2400/13

(57) ABSTRACT

A phase plug for compression drivers comprises a single-part body with at least one acoustic channel, at least a portion of a boundary forming the channel is contained within the perimeter of the single-part body, while the remaining portion is formed by an electrodynamic motor structure, where a continuous radial joint is provided between the single part body and motor structure, eliminating small contact points and preventing phase plug displacement during assembly, such that the design enables molding with lack of undercut while maintaining acoustic channel geometry and providing stable mechanical datum surfaces for reliable long-term attachment.

### CROSS REFERENCE TO RELATED APPLICATION

This U.S. non-provisional patent application claims the benefit of and priority to U.S. Provisional Patent Application No. 63/753,191, titled Novel Multiple Channel Phase Plug for Compression Drivers, and filed Feb. 3, 2025, which is incorporated in its entirety by reference herein.

### TECHNICAL FIELD

Embodiments relate to acoustic devices, specifically phase plug assemblies for compression drivers used in professional audio applications. The phase plug assembly utilizes a novel mounting configuration that integrates molded components with the electrodynamic motor structure to achieve improved mechanical stability and manufacturing efficiency for single-piece phase plugs. More particularly, embodiments relate to phase plug designs where a portion of an outer phase plug channel boundary is contained within the perimeter of the molded component, enabling continuous radial joint contact. This improves the positioning accuracy and bonding interface of the phase plug component with the compression driver motor assembly, which requires tight tolerances.

### BACKGROUND OF THE INVENTION

Compression drivers are widely used in professional audio applications for high-frequency sound reproduction. A compression driver 10 comprises (FIG. 1) a diaphragm assembly 12, an electrodynamic motor structure 14, and a phase plug 16. The diaphragm assembly 12 consists of a moving component (typically a thin plastic or metal dome or annulus) attached to a voice coil, clamping fixtures that position the diaphragm assembly within the motor structure's air gap, and the phase plug 16 adjacent and closely displaced from the diaphragm assembly 12. The space between the diaphragm outer surface and the phase plug inner surface is known as the compression chamber. The air trapped in the compression chamber is locally stiffer near the diaphragm surface, and this improves energy transfer from the diaphragm to the air. The phase plug 16 contains one or more acoustic channels 18 (FIGS. 1, 3) that guide sound energy from the compression chamber to the driver's exit 20. The face of the phase plug adjacent to the compression chamber has a series of openings or slits that allow sound to enter the acoustic channels. The slits are commonly radial, but sometimes there are other geometries. In either case, they are usually radially distributed about the central rotational axis of the phase plug.

The compression chamber formed between the diaphragm and phase plug has multiple resonant modes within the audio frequency range that are dependent on the chamber’s dimensions. Since compression drivers are typically designed for frequency ranges up to 20kHz, effective modal control results from strategic placement of acoustic channels along the chamber boundary to suppress the modal behavior in a specific frequency range. To prevent excitation of these acoustic modes, acoustic channels that allow sound to exit the compression chamber are positioned at node locations corresponding to acoustic modes of the compression chamber. Larger diaphragms have larger compression chambers, more modes, and more acoustic channels to prevent mode excitation. Typical compression drivers 10 (FIGS. 1, 3) have between one and four acoustic channels 18 from the compression chamber to the acoustic exit 20 of the driver 10. These channels 18 allow sound to propagate from the compression chamber, through the phase plug 16, to the acoustic exit 20 of the driver. Downstream of the driver exit 20 is typically an impedance matching device like a horn flare, waveguide, or wave plate.

Traditional phase plug designs face significant manufacturing and assembly challenges. The complex channel geometries required for optimal acoustic performance often contain features that overlap themselves, like undercuts, that prevent use of certain types of manufacturing process (e.g. traditional injection molding). Consequently, many phase plugs must be divided into multiple parts and assembled (FIG. 2). This increases cost, complexity, and can cause tolerance stack-up issues. As seen in FIGS. 2(a)-(c), this prior art phase plug 16 has an outer portion 16’, that receives a middle portion 16’’, that receives a central portion 16’’’, where the various portions nest together in such a way as to form the acoustic channels 18. FIG. 2(c) shows the nested phase plug 16 disposed within the compression driver 10. The compression chamber 30 is formed between the diaphragm 12 and the nested phase plug 16. The air gap and voice coil 32 are disposed within the electrodynamic motor structure 14 radially outward of the phase plug 16. The compression driver 10 is closed opposite from the acoustic exit 20 by a back cover 34. In this version of the prior art, an outermost acoustic channel 24 of the phase plug 16 is formed within the phase plug itself by an inner surface of the outer portion 16’ and by an outer surface of the middle portion 16’’. As a result, an outer surface of the outer portion 16’ of the phase plug 16 engages the electrodynamic motor structure 14 when the phase plug 16 is disposed within the driver 10 (FIG. 2(c)). This nested construction increases the number of components necessary to form the plug. Additional components have the potential for tolerance stack-up concerns during assembly and engagement with the electrodynamic motor structure. Such prior art is used to enable undercuts, or other features that are not compatible with the requirements typical in manufacturing from molds.

One method to avoid undercuts is found in US 12,149,906 B2, where a helical acoustic channel can be successfully molded without undercuts. But even here, the final assembly consists of multiple parts that need to be assembled together. The more components, the more assembly and geometry errors have potential to accrue.

Phase plug geometries seek to minimize the obstruction of sound energy through the acoustic channels. The assembly of the various parts of the phase plug (16′, 16″, 16‴ in FIG. 2) is carried out by positioning and affixing one part inside another. In order not to obstruct the airflow within the openings of the phase plug (18), the contact points between the various parts forming the phase plug (16′, 16″, 16‴) must be as small as possible.

In some cases, it is possible to define a phase plug geometry that avoids undercuts and allows geometry to be integrated such that they can be manufactured as a single-piece part, such as prior art single-piece phase plugs., As noted above, mating and assembly features for these single-part phase plugs are made as small as feasible to avoid acoustic obstruction. This requires the phase plug 16 to contact the motor structure at only a few, small points 22, thereby creating potential for mechanical instability (FIGS. 3-4). For these molded single-piece phase plugs 16 of prior art designs, the outermost phase plug acoustic channel 24 is formed by two separate pieces of the assembly adjacent to each other. The outer surface of the outer acoustic channel 24 is defined by an inner face 26 of the electrodynamic motor assembly 14; the inner surface of the acoustic channel 24 is delineated by the outer wall 28 of the single-piece phase plug 16. Here, the phase plug 16 is supported on the inner face 26 of electrodynamic motor structure 14 by the connecting elements 22 which extend from the outer wall 28 of the phase plug 16 (FIG. 4(b)).

This version of the prior art can be described in the following manner: the inner face 26 of the motor 14 creates a “basket” for the phase plug 16 to rest in (FIGS. 3-4). The basket of the motor structure is commonly contacted by the contact points 22 of the phase plug 16, typically three or four small ribs or pins that protrude from the outer wall 28 of the phase plug 16, displacing the phase plug 16 a small distance from the motor assembly 14, thus forming the outermost acoustic channel 24.

The limited contact area between the protruding portions of the prior art and the basket of the motor can give rise to mechanical errors of location during the assembly process. Off-center, off-height, or rocked displacement of the phase plug within the motor structure results in potential for the compression chamber position and dimensions to be out of tolerance. This degrades acoustic performance and can even cause mechanical interference with the diaphragm. Further, the minimal surface area of the protruding portions may provide insufficient area for reliable long-term attachment of the single-piece phase plug to the motor.

Existing manufacturing approaches struggle with the conflicting requirements of molding feasibility and acoustic channel optimization. Draft angles required for part extraction may compromise channel geometry, while undercut-free designs can limit acoustic performance. The challenge lies in achieving more optimal channel shapes while maintaining single-piece moldability and reliable affixment to the motor structure.

### BRIEF SUMMARY

To address and solve the problems of the prior art, the present invention provides a novel phase plug assembly design that enables single-piece molding while providing improved mechanical attachment, mating tolerances, and acoustic performance. The design relocates a portion of the phase plug's outer channel boundary to the molded component. This creates larger contact surfaces with continuous radial perimeter between the phase plug and the electrodynamic motor structure. The result is more area for gluing or other attachment, improved assembly datums, and less likelihood for errors during assembly.

The phase plug assembly comprises a single molded part with one or more acoustic channels configured to guide sound energy from a diaphragm, through the phase plug, and to the compression driver exit. A portion of the outermost acoustic channel boundary is contained within the perimeter of the molded body, while any remaining outer channel boundary is defined by geometry of motor structure. The single-piece part body incorporates appropriate draft angles for part extraction while maintaining acoustic channel geometry through strategic division of the overall acoustic channel path between phase plug and motor sub-assemblies.

This configuration enables a continuous radial joint between the phase plug and motor structure. The radial joint provides substantially larger attachment area compared to the prior art’s use of protruding portions. This ensures reliable long-term attachment during operation. Further, the configuration of the affixing location as radially continuous enables stable placement and automation for dispensing of an adhesive or other bonding agent.

Unlike existing designs requiring multiple sub-assembly parts or compromised mounting, this design achieves both improved acoustic channel geometry and robust mechanical design with a single-piece body component suitable for injection molding.

### BRIEF DESCRIPTION OF THE DRAWINGS

For a more complete understanding of this disclosure, reference is now made to the following brief description, taken in connection with the accompanying drawings and detailed description, wherein like reference numerals represent like parts, in which:

FIG. 1 is an exploded view of a prior art compression driver assembly showing the phase plug, motor structure, and diaphragm components of a compression driver;

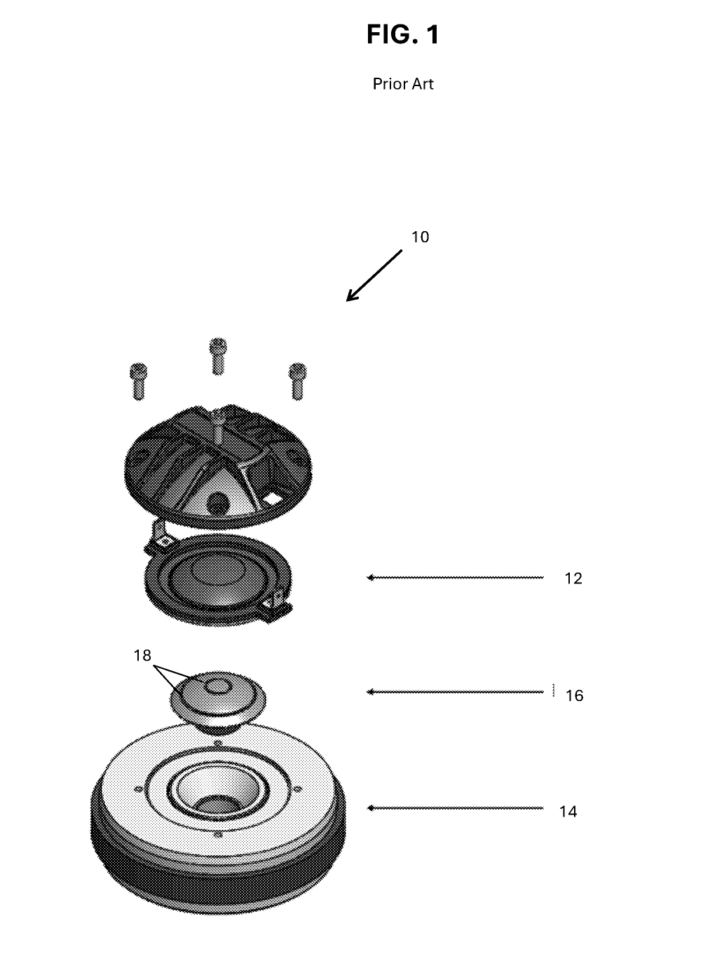

FIGS. 2(a)-(c) show various views of a multiple channel phase plug assembly of the prior art comprised of multiple nested sub-components;

FIG. 3 is a cross-sectional view of a prior art single-piece phase plug placed inside the compression driver motor structure. It shows the outer channel being delineated by both the motor structure and the molded piece.;

FIGS. 4(a) and (b) are perspective and cross-sectional views illustrating the protruding portions that protrude from the surface of a prior art single-piece body phase plug;

FIG. 5 is a cross-sectional view of a single-piece phase plug embodiment showing a portion of the outermost acoustic channel contained within the molded part;

FIG. 6 is a partial cross-sectional view and a partial enlargement thereof showing a single-piece phase plug embodiment showing the mating surfaces and datum faces according to an embodiment;

FIG. 7 is a top view of the single-piece phase plug; and

FIG. 8 is a bottom view of the single-piece phase plug.

FIG. 9 is cross-sectional view of a mold in a closed position during formation of the single-piece body of the phase plug assembly;

FIG. 10 is cross-sectional view of a mold in an open position showing withdrawal of the formed single-piece part of the phase plug;

FIG. 11 is a cross-sectional view of the single-piece part phase plug of FIG. 5 in an alternative embodiment having a single acoustic channel;

FIG. 12 is a partial enlarged view showing the phase plug of FIG. 11 disposed in an electrodynamic motor structure of a compression driver;

FIG. 13 is a top view of the phase plug of FIG. 11; and

FIG. 14 is a bottom view of the phase plug of FIG. 11.

### DETAILED DESCRIPTION

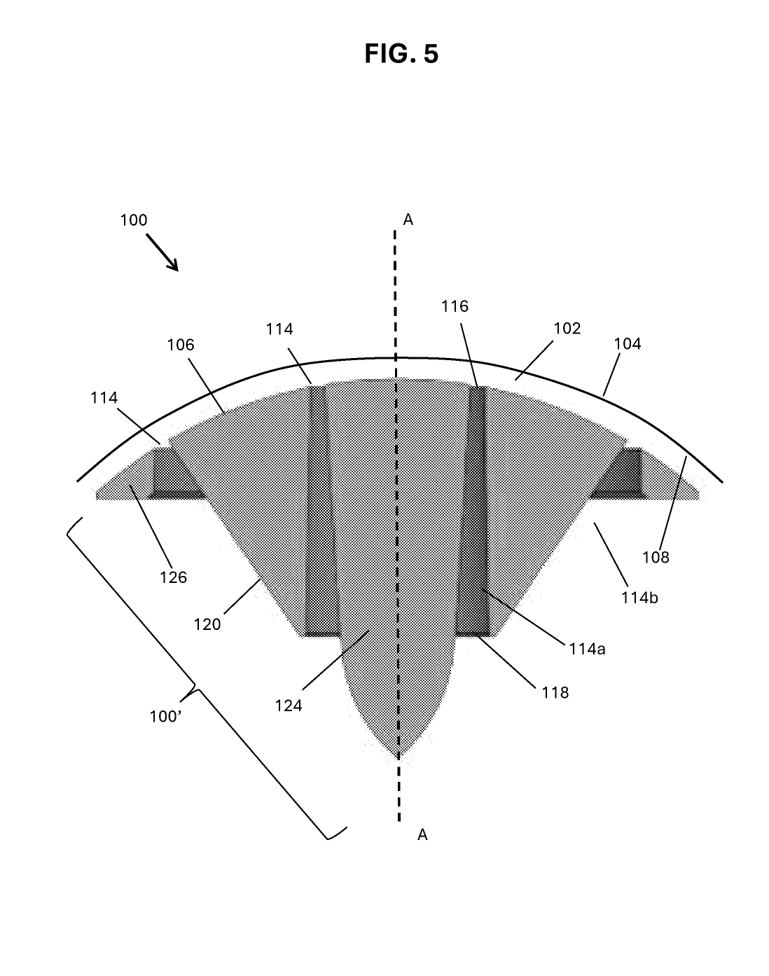

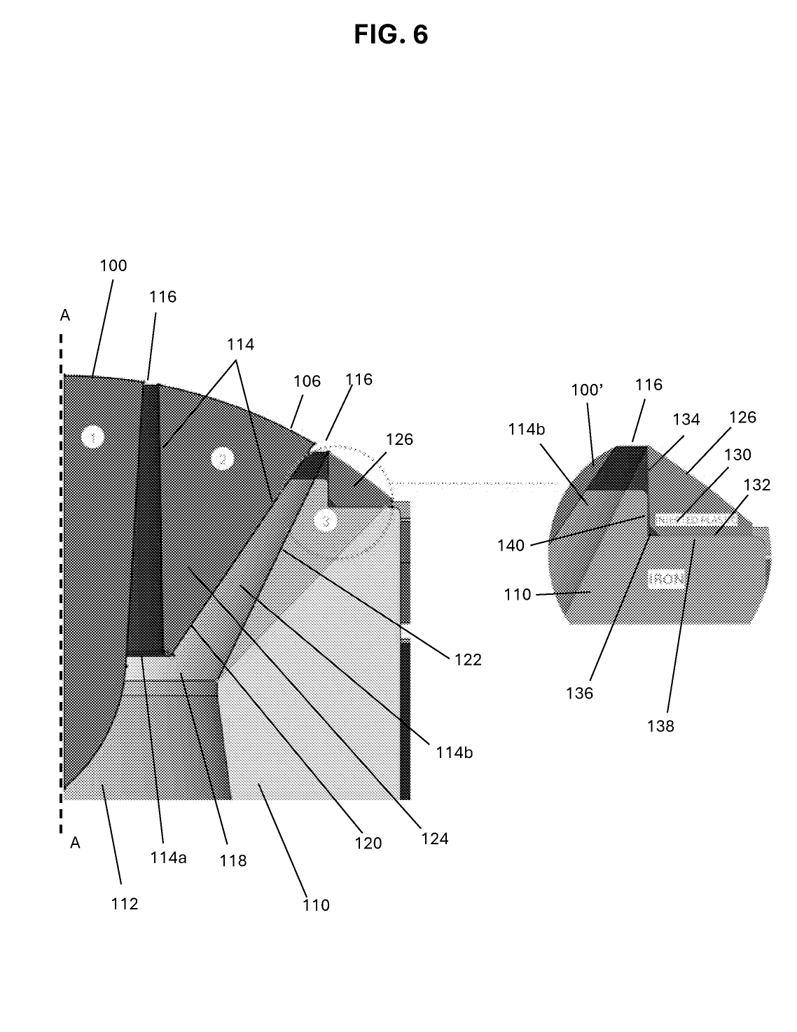

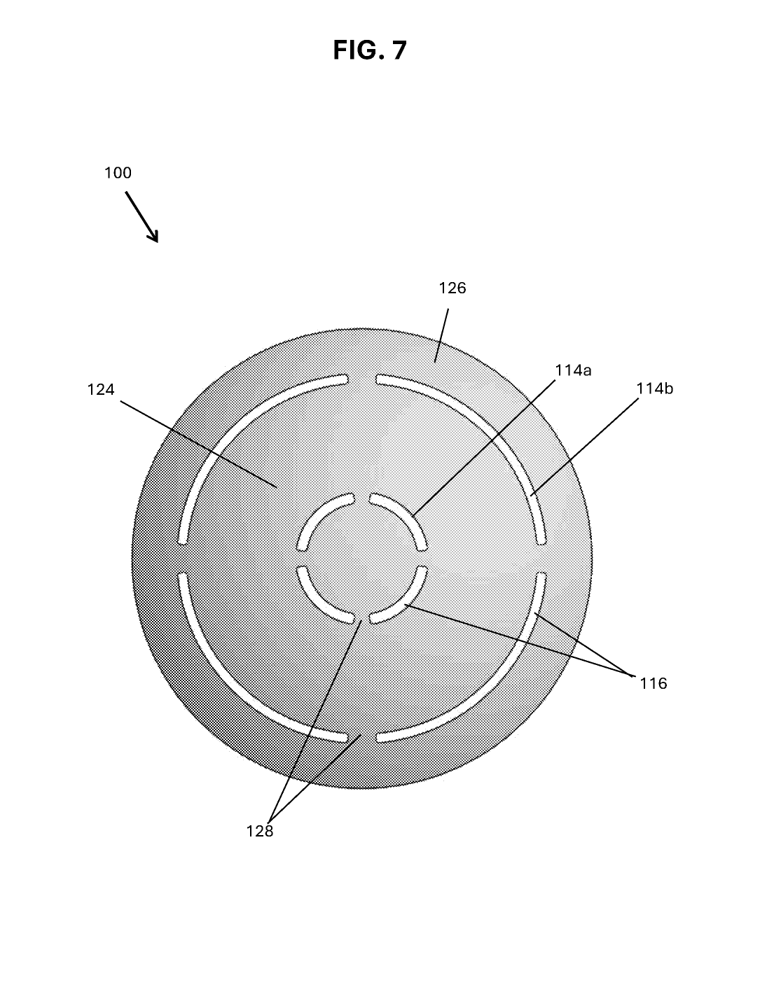

FIGS. 5-8 show cross-sectional, top, and bottom views of a novel single-piece part phase plug 100 in one exemplary embodiment of the invention. The phase plug 100 is configured to be disposed operably within a compression driver having an electrodynamic motor structure 110. The phase plug 100 forms a compression chamber 102 with an oscillating diaphragm 104. Particularly, a boundary face 106 of the phase plug 100 is arranged adjacent to an inner surface 108 of the diaphragm 104 to form the compression chamber 102 therebetween. The compression driver includes a singular acoustic exit 112 defined by a termination of the phase plug 100. The phase plug 100 includes at least one acoustic channel 114 which traverses through the phase plug 100 from the compression chamber 102 to terminate at the acoustic exit 112 (FIG. 6). In a preferred embodiment, the phase plug 100 includes an inner channel 114a and an outer channel 114b. Both the inner and outer channels 114a, 114b extend around a central axis of rotation A-A of the phase plug 100, where the outer channel 114b is arranged radially outward of the inner channel 114a.

The central axis of rotation A-A is defined within an interior of the phase plug 100, and extends from the boundary face 106 of the phase plug 100 at the compression chamber 102 to the acoustic exit 112. The phase plug 100 is arranged symmetrically around the axis of rotation A-A.

As shown in the drawings, the phase plug 100 comprises a single-part body 100’. That is, the body 100’ of the phase plug 100 is one piece part and may be molded as a single unit without requiring manufacturing and assembly of multiple parts.

The acoustic channel 114 traverses through the single-part body 100’ of the phase plug 100, between a respective entrance 116 at the boundary face 106 of the phase plug 100 and a termination 118 of the acoustic channel 114 at the acoustic exit 112.

The outer acoustic channel 114b extends from the channel entrance 116 at the boundary face 106 of the phase plug 100 to the acoustic channel exit 118 at the single acoustic exit 112 of the phase plug 100. Along this extension, the outer acoustic channel 114b is defined by an outer surface 120 of the phase plug 100’ and an outer surface 122 of the electrodynamic motor structure 110. See, particularly, FIG. 6. This is unlike the inner acoustic channel 114a which is wholly delimited by the material forming the phase plug 100.

Importantly, the single-part body 100’ of the phase plug 100 is formed without undercuts to allow ease of withdrawal from a mold during manufacturing.

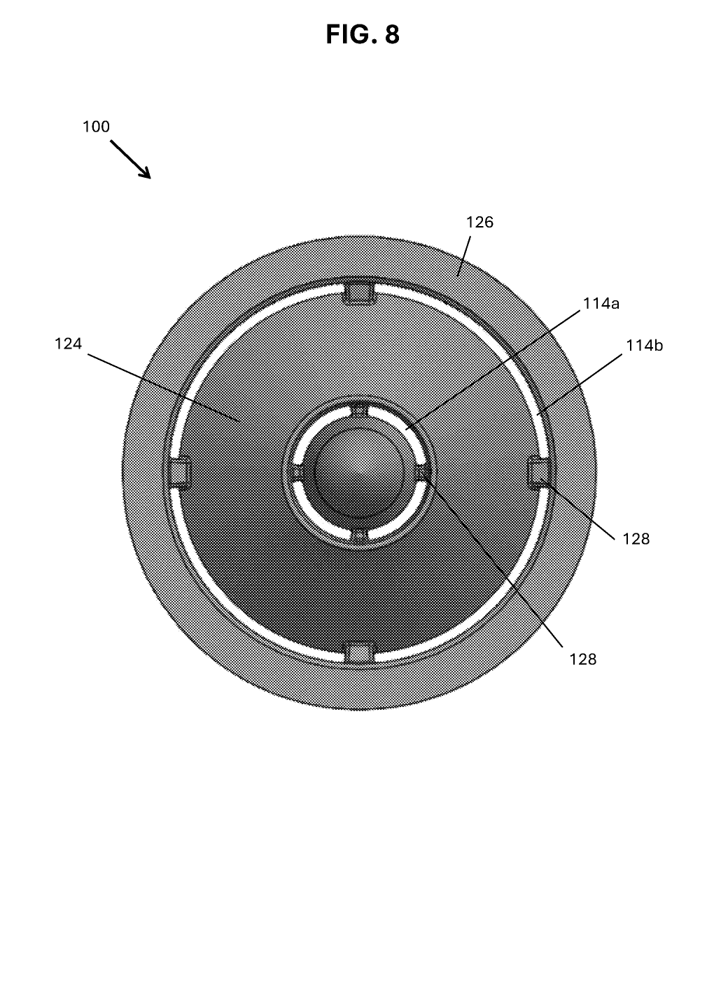

As described, the phase plug 100 is formed of a single-piece, single-part body 100’. This single-part body 100’ contains two regions: a central region 124; and a radial interface region 126. A plurality of connecting elements 128 may serve as a bridge between the central region 124 and the radial interference region 126 (FIG. 8).

The central region 124 includes, on one side, a domed surface which contains the boundary face 106 of the phase plug 100 and, on the opposite side, a bulbous portion which extends into the single acoustic exit 112. The central region may be a solid occluding element, or may include one or more acoustic channels 114 extending symmetrically about the axis A-A and extending from the compression chamber 102 to the single acoustic exit 118 in order to allow acoustic energy from the compression chamber 102 to radiate to the exit 112. The central region 124 additionally includes the outer surface 120 of the phase plug 100 and thus, along with the outer surface 122 of the electrodynamic motor structure 110, serves to delimit the outer acoustic channel 114b.

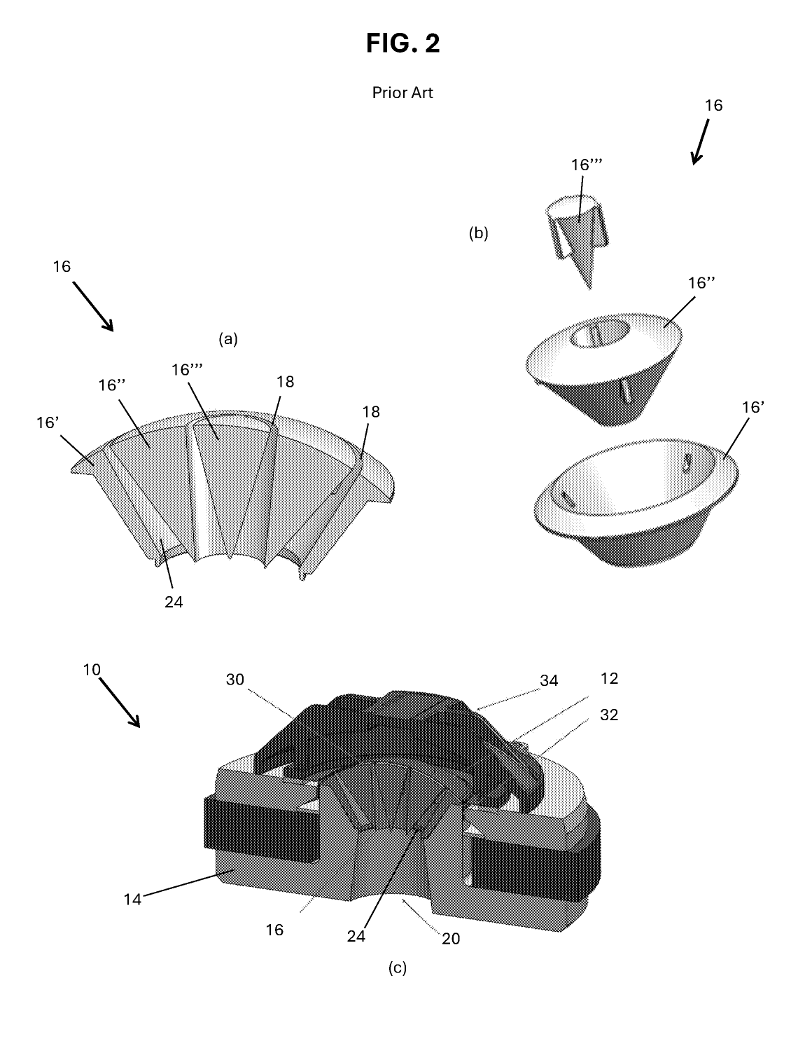

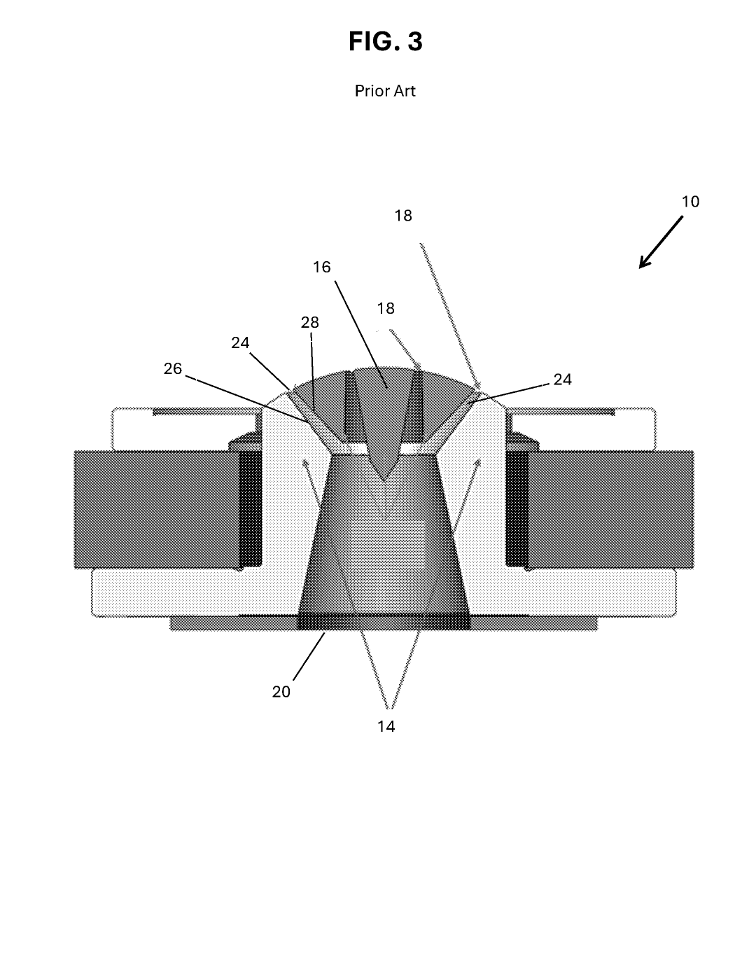

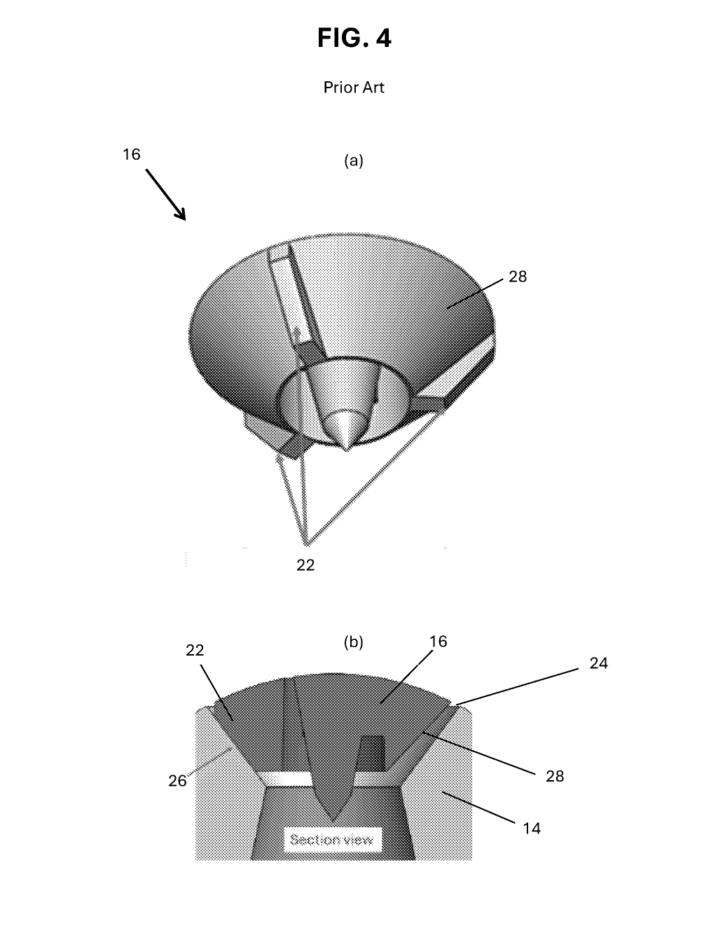

The radial interference region 126 extends symmetrically about the axis A-A, radially outward of the central region 124. The region 126 is shaped and configured to generally provide interference between the phase plug 100 and the compression driver motor structure 110. That is, the radial interference region 126 defines a continuous radial joint extending around substantially an entire perimeter of a phase plug attachment interface. This continuous radial joint provides an enlarged contact surface between the phase plug 100 and the motor structure 110, while still maintaining a continuous joining interface around the perimeter of the phase plug attachment point. This is accomplished by essentially relocating the outer acoustic channel 114b within the injection molded phase plug single-piece body 100’, as opposed to the prior art which either forms the outer channel by nesting multiple pieces to form a phase plug (FIG. 2) or by relying on external contact points to support a phase plug within the basket of a motor structure (FIGS. 3-4). That is, in the present embodiment, the outermost acoustic channel 114b is contained within the perimeter of the molded phase plug single-part body 100’. Here the outermost acoustic channel 114b is delimited, on the one hand, by the outer surface 120 of the phase plug 100 and, on the other hand, by the outer surface 122 of the electrodynamic motor structure 122. Yet, due to the radial interference region 126, the outermost perimeter of the phase plug 100 extends outwardly of the outermost acoustic channel 114b and forms an engagement surface with the electrodynamic motor structure 122 which may receive and retain glue for sealing the phase plug 100 to the motor 122.

As shown in detail in FIG. 6, at the boundary between the phase plug 100 and the motor structure 110, the radial interference region 126 has at least one datum face 130 defining an attachment surface between the phase plug body 100’ and the motor structure 110. In one embodiment, the datum face 130 may comprise a first substantially planar surface 132, arranged generally transverse to the axis A-A, where the first planar surface 132 extends around the perimeter of the phase plug 100. The datum face 130 may further include a second substantially planar surface 134, arranged generally parallel to the axis A-A, where the second planar surface 134 also extends around the perimeter of the phase plug 100. A relief 136 may be located at the intersection of the first and second planar surfaces 132, 134. The relief 136 may comprise a surface arranged at an angle to both the first and second planar surfaces 132, 134 so as to angularly adjoin these two faces. The relief 136 may additionally or alternatively comprise a curved surface, or may comprise a curvilinear or rectilinear groove, adjoining the first and second planar surfaces 132, 134.

The relief 136 extends about the axis A-A around the perimeter of the phase plug 100 and is configured to accommodate a volume of adhesive material entrained between the mating surfaces of the radial interference region 126 of the phase plug 100 and the corresponding surface of the electrodynamic motor structure 110. The relief 136 essentially comprises a gap, groove, angled surface, or the like positioned adjacent to the mating surfaces of the phase plug body 100’ and the motor structure 110.

The datum face 130 is shaped, sized, and configured to prevent rotational and/or translational displacement of the phase plug body 100; relative to the motor structure 110 during operation of the compression driver. This is accomplished largely by engagement of the first and second planar surfaces 132, 134 with corresponding surfaces of the electrodynamic motor structure 110.

The first planar surface 132 of the datum face 130 engages a corresponding first planar surface 138 of the electrodynamic motor structure 110 which said surface 138 extends similarly to the first planar surface 132, i.e., in one direction the planar surface 138 extends transverse to the axis A-A and, in another direction, extends around the perimeter of the phase plug 100. Friction between the first planar surface 132 of the phase plug 100 and the corresponding planar surface 138 of the motor structure 110, and/or the application of adhesive therebetween, prevents rotational movement of the phase plug 100 upon the planar surface of the electrodynamic motor structure 110.

The second planar surface 134 of the datum face 130 engages a corresponding second planar surface 140 of the electrodynamic motor structure 110 which said surface 140 extends similarly to the second planar surface 134, i.e., in one direction the planar surface 140 extends parallel to the axis A-A and, in another direction, extends around the perimeter of the phase plug 100. Friction between the second planar surface 134 of the phase plug 100 and the corresponding planar surface 140 of the motor structure 110, and/or the application of adhesive therebetween, prevents rotational movement of the phase plug 100 upon the planar surface of the electrodynamic motor structure 110. Additionally, the engagement of the second planar surface 134 of the phase plug 100 upon the corresponding surface 140 of the electrodynamic motor 110 prevents lateral movement of the phase plug 100 relative to the motor 110.

The second surface 134 of the phase plug 100 and the corresponding second surface 140 of the electrodynamic motor 110 are described herein as ‘planar’. This refers to the planar shape of the surfaces 134, 140 as illustrated in cross-section in FIG. 6. Of course the surfaces 134, 140, in another axis, possess a curvature which extends the surfaces 134, 140 in circumferential fashion around the axis A-A.

The affixation of the phase plug 100 and the electrodynamic motor structure 110 has been described herein as being facilitated by adhesive, for example, applied at the relief 136 and/or between surfaces 132, 138 and/or between surfaces 134, 140. In other embodiments, the affixation may be alternatively or additionally accomplished by mechanical bonding and/or by friction fit.

As described, the disposition of the phase plug 100 within the electrodynamic motor structure 110 delimits at least the outermost acoustic channel 114b by aligning the outer surface 120 of the phase plug 100 with the outer surface 122 of the electrodynamic motor structure 110 (FIG. 6). The phase plug 100 may comprise the outermost channel 114b as the only acoustic channel extending therethrough. In other embodiments, the phase plug 100 may include one or more of the inner acoustic channels 114a. For example, the phase plug may comprise a first inner acoustic channel arranged concentrically around the phase plug axis A-A and a second inner acoustic channel also arranged concentrically around the phase plug axis A-A and radially outward of the first inner acoustic channel but radially inward of the outer acoustic channel. In this manner, the phase plug may comprise a third inner acoustic channel, and fourth inner acoustic channel, and so on, each additional inner acoustic channel arranged concentrically around the phase plug axis A-A and radially outward of the first inner acoustic channel but radially inward of the outer acoustic channel. The inner and outer acoustic channels 114a, 114b of the phase plug 100 extend, in one direction, from the boundary face 106 of the phase plug 100 to the single acoustic exit 118 and, in another direction, circumferentially around the axis A-A.

The first and second planar surfaces 132, 134 of the radial interference region 126 of the phase plug 100 have been thus far described as being transverse and parallel, respectively, to the axis A-A. This orientation is of course exemplary. In other embodiments, one or more of the first and second surfaces 132, 134 of the interference region 126 may be oriented at an angle to the axis A-A. The corresponding surface(s) 138, 140 of the motor structure 110 may be similarly oriented angularly relative to the axis A-A. Also, the first and second surfaces 132, 134 of the interference region 126 and the corresponding surfaces 138, 140 of the electrodynamic motor 110 have thus far been described as planar. This again is merely exemplary. These surfaces may take any shape sufficient to promote the desired engagement between the phase plug 100 and the electrodynamic motor 110.

In an embodiment, at least one of the acoustic channels 114 of the phase plug 100 has a circular or annular cross-section at the boundary face 106 of the phase plug 100. In an embodiment, at least one of the acoustic channels has a dimension and/or a placement about the axis of rotation A-A to allow for modal control of acoustic modes within the compression chamber 102. In an embodiment, at least one of the channels 114 expands in cross sectional area between the respective entrance 116 at the boundary face 106 of the phase plug 100 and the termination 118 at the acoustic exit 112.

In an exemplary preferred embodiment, the single-part body phase plug comprises a multichannel (>1 channel) phase plug for compression drivers, where the phase plug is processed by injection molding, the phase plug is tooled in one part, an outer acoustic channel of the phase plug is contained within the perimeter of the molded part and has an inner boundary delimited by the phase plug and an outer boundary delimited by the iron motor structure, where the joint between the phase plug and the motor structure must be radially continuous, include at least one datum face defined by a mating surface between the injection molded phase plug and the iron motor structure, and must be configured to accommodate a volume of adhesive material entrained between the mating surfaces.

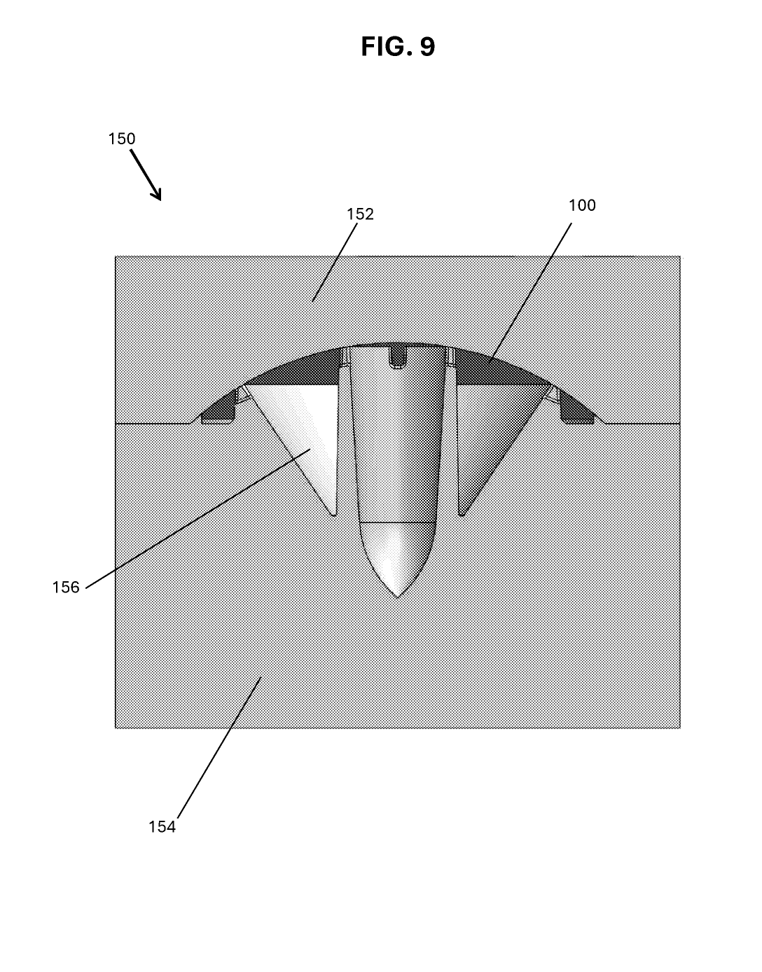

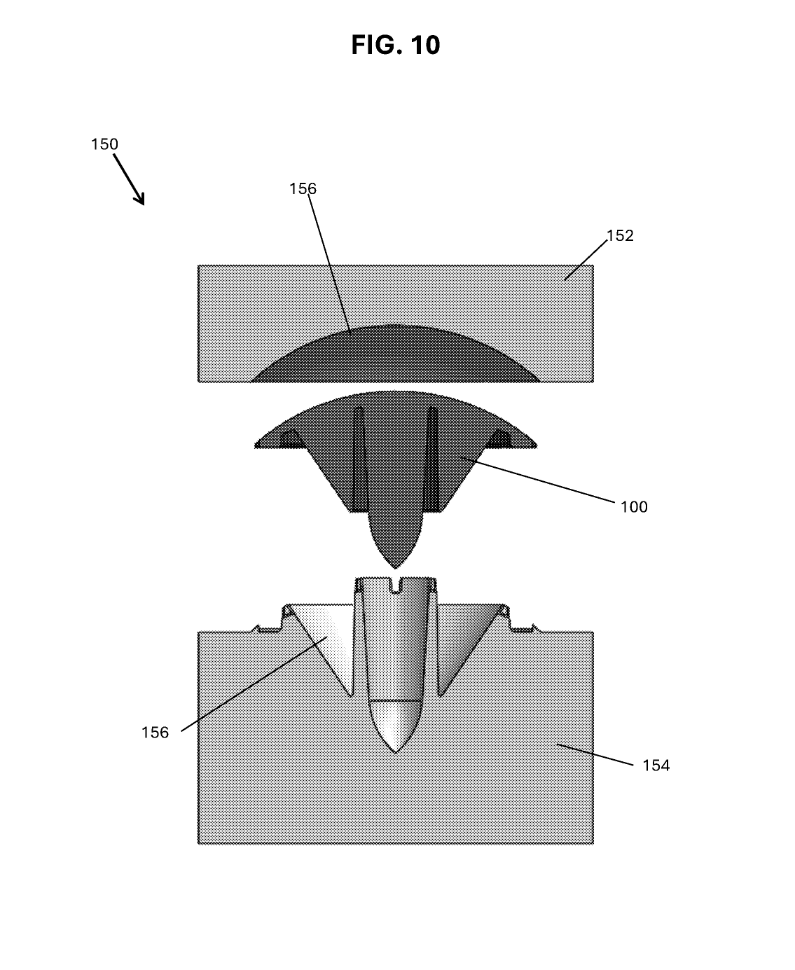

FIGS. 9-10 show an exemplary mold 150 for injection molding of the phase plug 100. The mold 150 includes two halves 152, 154 which, when in a closed position (FIG. 9), combine to form an interior cavity 156 having a shape of the negative of the phase plug 100. Injection molding material is inserted into the interior cavity 156 when the mold 150 is in the closed position. When curing is complete, the mold 150 is moved to the open position and the fully formed phase plug 100 is removed, free from undercuts. The phase plug 100 has a draft taper to facilitate extraction from the mold 150. Namely, FIGS. 9-10 demonstrate how the embodiment may easily be removed from the mold, due to simple parting line and adequate draft.

The phase plug 100 has been described illustratively with respect to FIGS. 5-8 as including two acoustic channels, an inner acoustic channel 114a and an outer acoustic channel 114b located radially outward of the inner acoustic channel 114a and formed partly by the motor structure of the compression driver in which the phase plug 100 is disposed. This channel configuration is exemplary. The broad scope of the invention contemplates the phase plug having less than two acoustic channels and more than two acoustic channels.

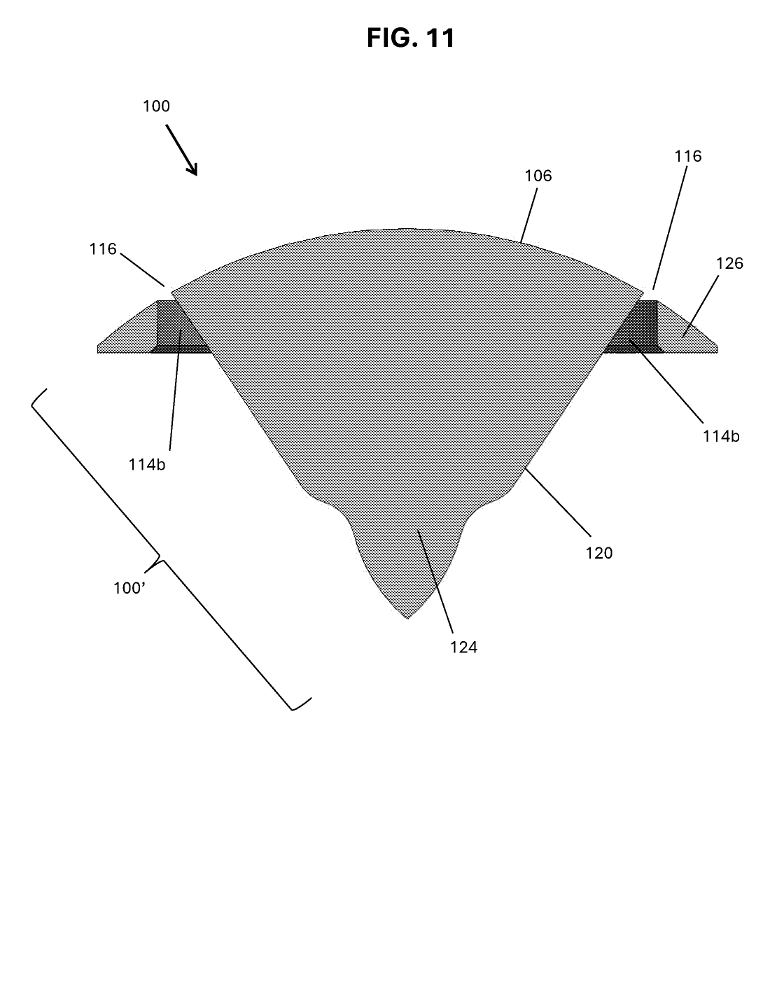

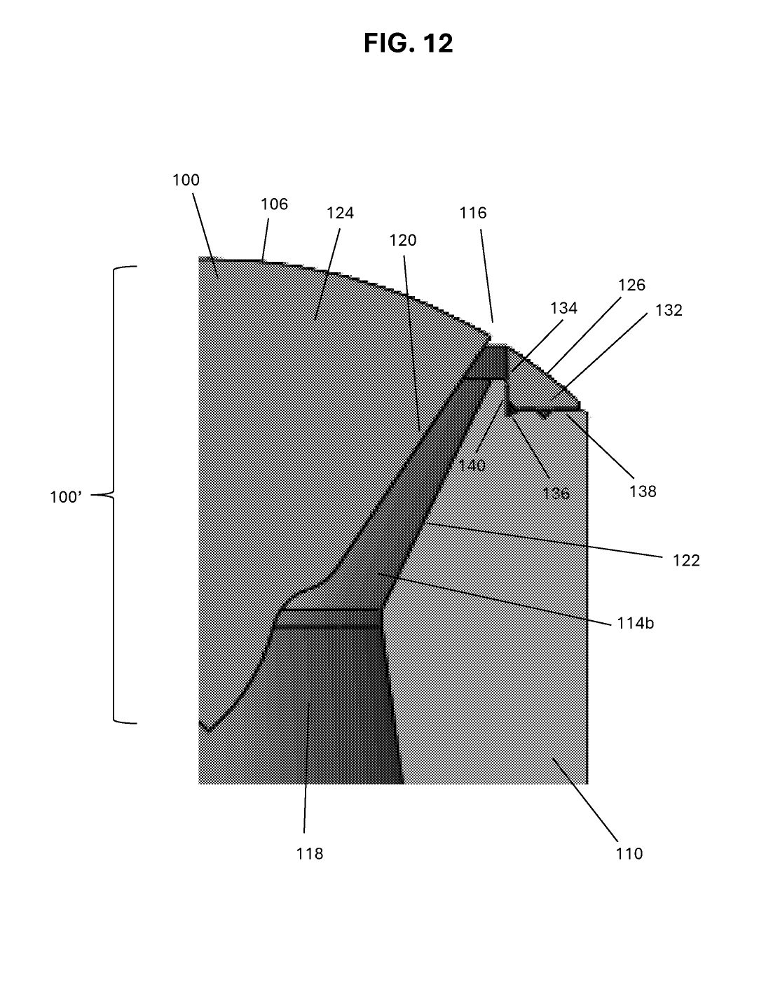

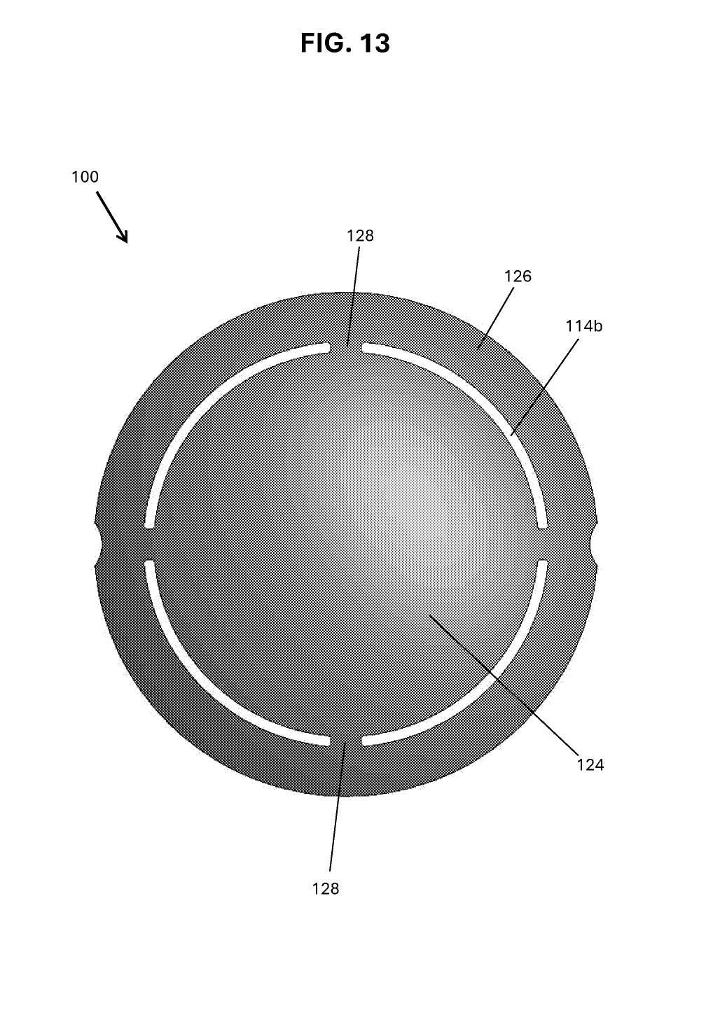

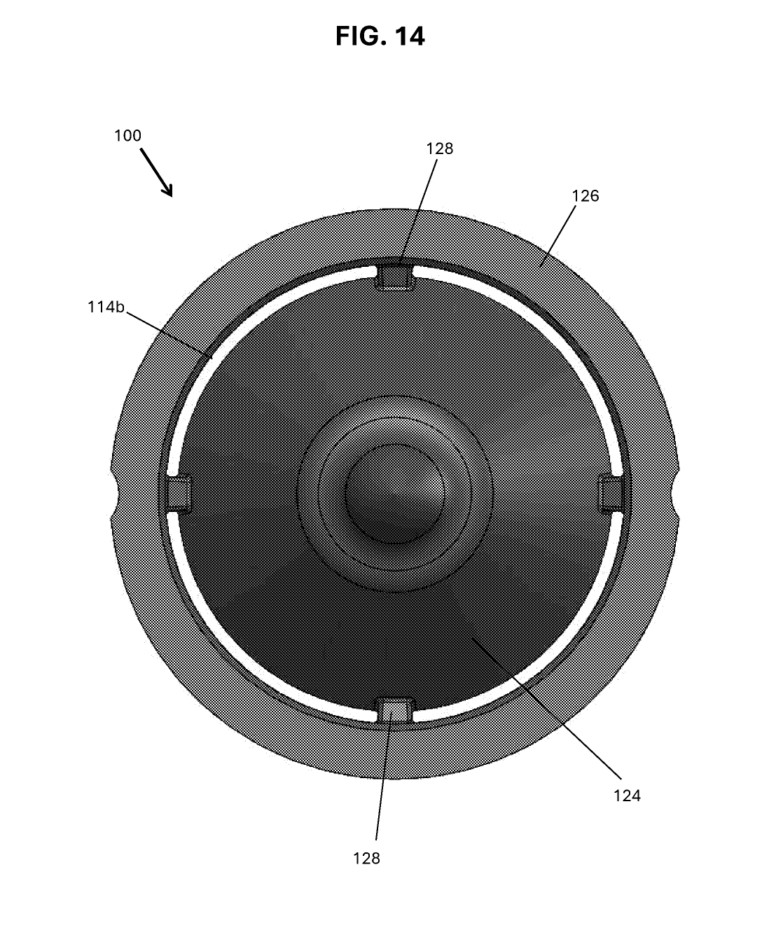

FIGS. 11-14 show an alternative embodiment of the phase plug 100 which includes the outer acoustic channel 114b but which omits the inner acoustic channel 114a. That is, the phase plug 100 of FIGS. 11-14 includes the single-part body 100’ formed of the central region 124 and the radial interference region 126, the radial interference region 126 being connected to the central region 124 by a plurality of the connecting elements 128. Here, the central region 124 is essentially a solid occlusion body having no channels formed therethrough. The outer acoustic channel 114b is the only channel formed through the plug body 100’ and is arranged within the perimeter of the plug body 100’. This channel 114b is formed, on the one hand, by the outer surface 120 of the central region 124 of the phase plug 100 and, on the other hand, by the outer surface 122 of the electrodynamic motor structure 110. See particularly, FIG. 12. The radial interference region 126 extends radially outward of the acoustic channel 114b and facilitates mating of the phase plug 100 with the electrodynamic motor structure 110 in the manner described previously and illustrated in both FIGS. 6 and 12.

The embodiments of the invention described herein address the shortcomings of prior art phase plug designs by introducing a single-piece, (i.e. single-part body) molded phase plug that incorporates both inner and outer acoustic channels within its body, while strategically relocating a portion of the outermost channel boundary to the molded component itself. This design enables the formation of a continuous radial joint between the phase plug and the electrodynamic motor structure, providing a substantially larger and more stable attachment system compared to the discrete contact points or multi-part assemblies found in conventional designs. The described configurations ensure precise positioning and robust mechanical integration, reduce tolerance challenges, and facilitate reliable bonding, all while maintaining optimal acoustic channel geometry and compatibility with standard molding processes. As a result, the invention achieves improved manufacturing efficiency, mechanical stability, and acoustic performance, effectively overcoming the cost, complexity, and reliability issues inherent in traditional phase plug assemblies.

Various embodiments of the present invention are described herein with reference to the related drawings. Alternative embodiments can be devised without departing from the scope of this invention. It is noted that various connections and positional relationships (e.g., over, below, adjacent, etc.) are set forth between elements in the description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship.

The term "exemplary" is used herein to mean "serving as an example, instance, or illustration." Any embodiment or design described herein as "exemplary" is not necessarily to be construed as preferred or advantageous over other embodiments or designs. The terms "at least one" and "one or more" are understood to include any integer number greater than or equal to one, i.e., one, two, three, four, etc. The term "a plurality" is understood to include any integer number greater than or equal to two, i.e., two, three, four, five, etc. Terms such as "connected to", “affixed to”, etc., can include both an indirect "connection" and a direct "connection."

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A phase plug assembly for a compression driver with an electrodynamic motor structure, comprising:
a. a compression chamber formed by an oscillating diaphragm and a boundary face of a phase plug adjacent to the diaphragm;
b. a singular acoustic exit defined by a termination of the phase plug;
c. an inner acoustic channel and an outer acoustic channel each traversing through the phase plug from the compression chamber to terminate at the acoustic exit; and
d. an axis of rotation, defined within an interior of the phase plug assembly, which extends from the boundary face of the phase plug at the compression chamber to the acoustic exit;
e. wherein the phase plug is arranged symmetrically around the axis of rotation;
f. wherein the phase plug comprises a single-part body;
g. wherein the inner and outer acoustic channels traverse between respective entrances at the boundary face of the phase plug assembly and respective terminations at the acoustic exit; and
h. wherein the inner and outer acoustic channels are both delimited in the single-part body within an outer perimeter of the phase plug;
i. wherein the outer acoustic channel is formed by an outer surface of the single-part body and by an outer surface of the electrodynamic motor structure; and j. wherein the single-part body is formed by molding and without undercuts.

2. The phase plug of claim 1, wherein the phase plug comprises a central region and a radial interference region radially outward of the central region, wherein the radial interference region engages the electrodynamic motor structure;

3. The phase plug of claim 2, wherein the radial interference region comprises a continuous radial joint that extends around substantially an entire perimeter of the phase plug.

4. The phase plug of claim 2, wherein the radial interference region comprises at least one datum face defining an attachment surface between the single-part body and the electrodynamic motor structure;

5. The phase plug of claim 1, wherein at least one of the inner and outer acoustic channels has a circular or annular cross-section at the boundary face of the phase plug.

6. The phase plug of claim 5, wherein at least one of the inner and outer acoustic channels has dimensions and a placement about the axis of rotation to allow for modal control of compression chamber acoustic modes.

7. The phase plug of claim 3, wherein the engagement of the single part body with the electrodynamic motor structure is achieved through adhesive and/or mechanical bonding.

8. The phase plug of claim 7, wherein the joint between the single-part body and the electrodynamic motor includes at least one relief to accommodate a volume of adhesive material entrained between the mating surfaces.

9. The phase plug of claim 8, wherein the relief comprises a gap positioned adjacent to the mating surfaces between single-part body and the electrodynamic motor structure.

10. The phase plug of claim 8, wherein the relief comprises a circumferential groove formed in at least one of single-part body and/or the electrodynamic motor structure.

11. The phase plug of claim 2, wherein the at least one datum face prevents translational and/or rotational displacement of the single-part body relative to the electrodynamic motor structure during operation.

12. The phase plug of claim 1, wherein at least one of the inner and outer channels expands in cross sectional area between the respective entrance at the boundary face of the phase plug, and the termination at the acoustic exit.

13. The phase plug assembly of claim 1, wherein the single-part body further comprises a plurality of connecting elements extending between the central region and the radial interference region to provide structural reinforcement.

14. The phase plug assembly of claim 1, wherein the phase plug is configured such that the inner and outer acoustic channels are positioned at node locations of acoustic modes of the compression chamber.

15. The phase plug assembly of claim 4, wherein the datum face comprises a first planar surface generally transverse to the axis of rotation, a second planar surface generally parallel to the axis of rotation, and a relief extending between the first and second planar surfaces and configured to receive and retain adhesive, the first and second planar surfaces and the relieve extending continuously around a circumference of the phase plug.

16. The phase plug of claim 4, wherein the datum face is configured to secure the single-part body to the electrodynamic motor structure and to position the outer surface of the single-part body adjacent to the outer surface of the electrodynamic motor structure to form the outer acoustic channel.

17. The phase plug of claim 1, wherein the inner acoustic channel comprises a plurality of channels arranged concentrically around the axis of rotation, each of the plurality of channels traversing through the phase plug from the compression chamber to terminate at the acoustic exit.

18. A phase plug for a compression driver, comprising:
a single-piece body configured to be disposed within a compression driver having an electrodynamic motor structure;
at least one outer acoustic channel extending through the single-piece body from a boundary face adjacent to a diaphragm to an acoustic exit;
wherein a portion of an outer boundary of the outer acoustic channel is defined by the single-piece body and a remaining portion is defined by the electrodynamic motor structure;
wherein the single-piece body is formed by a molding process without undercuts;
wherein the single-piece body includes a continuous joint surface configured to engage the electrodynamic motor structure around a perimeter of the phase plug; and
wherein the continuous joint surface is disposed radially outward of the outer acoustic channel.

19. The phase plug of claim 17, wherein the continuous joint surface comprises a relief configured to receive and retain adhesive for securing the single-part body to the electrodynamic motor structure, and wherein continuous joint surface is shaped to and configured to prevent lateral and rotational movement of the single-part body when secured to the electrodynamic motor structure.

20. The phase plug of claim 18, further comprising an inner acoustic channel extending through the single-part body from the boundary face adjacent to the diaphragm to the acoustic exit, the inner acoustic channel disposed radially inward of the outer acoustic channel.
